(19) United States
(12) Patent Application Publication
(10) Pub. No.: US 2011/0015979 A1
(43) Pub. Date: Jan. 20, 2011

(54) Methods and Systems for Awarding Discounts for Experiencing Advertising

(76) Inventors: Bart Allan Mansdorf, Lexington, KY (US); Dell T. Rosa, Winchester, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/505,587

(22) Filed: Jul. 20, 2009

(51) Int. Cl. G06Q 30/00; G06F 3/048

(52) U.S. Cl. 705/14.21; 705/14.39; 705/14.37; 705/14.73; 715/760

(57) ABSTRACT

A discount may be earned in exchange for experiencing an advertisement. In an example embodiment, a method includes causing information corresponding to a product to be presented. An option to experience an advertisement is also presented. Further, a discount indicator is caused to be presented. The discount indicator indicates that selecting the option enables a discount on the product to be acquired. In another example embodiment, a method includes providing an option to experience an advertisement in exchange for a discount on a product. In response to a user selecting the option to experience the advertisement, the advertisement is presented to the user. After the advertisement has been presented, the discount on the product is awarded to the user.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

This description relates generally to the hardware and the software arts, and more specifically but by way of example and not limitation, to awarding discounts to users in exchange for experiencing advertising using hardware devices and/or software stored on one or more memories.

2. Description of the Related Art

Replacement ink jet cartridges and other imaging device supplies are sold online as well as in retail stores. To purchase a new cartridge online, consumers typically search a web site for the appropriate cartridge and select it to add the item to their virtual shopping cart. The prices for various different cartridges are listed on web pages, and a final total is provided to the consumer when they are ready to check out and complete their purchase transaction. Alternately, in a retail store, consumers usually browse shelves and racks of cartridges, select the cartridge they desire, and take the product to a check-out area where the purchase transaction is completed.

In both on-line and retail environments, consumers often prefer to purchase items they are seeking based on the price. Consequently, they are often willing to buy from whichever web site or store location that will sell them a given product at the lowest available price. Hence, vendors are usually motivated to implement strategies, mechanisms, and technologies that will enable them to lower prices while maintaining the same or at least reasonable profit levels. Unfortunately, this often proves difficult to achieve in real-world settings.

### SUMMARY

A discount may be earned in exchange for experiencing an advertisement. In an example embodiment, a method is implemented by at least one device to enable a discount to be earned in exchange for experiencing an advertisement. The method includes causing information corresponding to a product to be presented. An option to experience an advertisement is also presented. Further, a discount indicator is caused to be presented. The discount indicator indicates that selecting the option enables a discount on the product to be acquired.

In another example embodiment, a method is implemented by at least one device to enable a discount to be earned in exchange for experiencing an advertisement. The method includes providing an option to experience an advertisement in exchange for a discount on a product. In response to a user selecting the option to experience the advertisement, the advertisement is presented to the user. After the advertisement has been presented, the discount on the product is awarded to the user.

In yet another example embodiment, an apparatus enables a discount to be earned in exchange for experiencing an advertisement. The apparatus includes at least one memory having processor-executable instructions and one or more processors that are configured to execute the processor-executable instructions. Upon execution of the processor-executable instructions, the apparatus is to provide an option to experience an advertisement in exchange for a discount on a product. In response to a user selecting the option to experience the advertisement, the advertisement is presented to the user. The apparatus is further configured to award the discount on the product to the user after the advertisement has been presented.

Additional embodiments are described and/or claimed herein. Example additional embodiments include, by way of example but not limitation, arrangements, memories, devices, systems, and so forth. Additional aspects are set forth in part in the Detailed Description, Drawings, and Claims that follow, and in part may be derived from the Detailed Description and Drawings, or can be learned by practice of the teachings herein. It is to be understood that both the foregoing general description and the following Detailed Description are exemplary and explanatory only and are not restrictive of the invention as disclosed or as claimed.

### BRIEF DESCRIPTION OF THE DRAWINGS

A more complete understanding of embodiments of the invention may be obtained by reference to the following Detailed Description when taken in conjunction with the accompanying Drawings wherein:

FIG. 1 is a block diagram illustrating an example approach for awarding discounts in exchange for experiencing advertisements.

FIG. 2 is a flow diagram of an example general method for awarding discounts in exchange for experiencing advertisements.

FIG. 3 is a block diagram that illustrates an example client-server environment in which embodiments may be implemented.

FIGS. 4A, 4B, and 4C depict example images for a web-based embodiment.

FIG. 5 depicts an example in-store device embodiment.

FIG. 6 is a flow diagram of an example specific method for awarding discounts in exchange for experiencing advertisements.

FIG. 7 is a block diagram of example devices that may be used to implement embodiments for awarding discounts in exchange for experiencing advertisements.

### DETAILED DESCRIPTION

It is to be understood that the invention is not limited in its application to the details of construction and the arrangement of components set forth in the following description or illustrated in the Drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

As described herein above, vendors are usually motivated to implement strategies, mechanisms, and technologies that will enable them to lower prices while maintaining the same or at least reasonable profit levels. To achieve a lower price than might otherwise be feasible for a vendor, the vendor can offer a consumer an opportunity to watch an advertisement prior to a purchase transaction. This viewing enables the vendor to sell an item for a price that is reduced, e.g., by the amount of funds generated from the advertisement. The consumer receives an item at a reduced cost. The vendor can maintain the same level of profit. The advertiser gains access to a willing audience that will view advertisements. This creates a win-win-win situation for all three parties involved in the transaction.

Recently, advertising is becoming increasingly difficult for advertisers as consumers deploy an armada of technological innovations to reduce or eliminate the distractions and clutter of marketing from invading their space and time. And yet, advertisers are becoming ever more industrious in their attempts to attract people's attentions by producing new and creative ways of pushing advertising content out to the consumer. A common form of advertising today is the internet pop-up window that displays a static image or a movie to advertise a company's product. Many times these advertisements are automatically blocked, or if not, they merely serve to annoy the consumer inasmuch as they interfere with the consumer's accessing of the content they desire. A better situation would be created if a consumer were to willingly experience an advertisement because of some perceived benefit, such as a reduced cost on one or more products.

Generally, advertisements may be experienced visually, aurally, or in both manners. Advertisements may include presentations directed to any products and/or activities for which an entity would wish to pay in order to secure a public audience. Such things as movie previews, television previews, political campaign ads, user surveys, traditional television ads, combinations of any of these, and so forth may be involved in such advertisements.

A specific example embodiment may entail a retail web site that offers goods for sale to a consumer. Such a web site employs a secondary purchase option that enables the consumer to receive a discount on a good in exchange for and following the viewing of advertising content. The discount amount that is applied to the purchase may depend on the available advertisements and the rates that are typically paid for them to be presented. While current advertising prices range significantly, the average cost for such an advertisement may still approach a value the consumer would consider valuable when it is applied to their purchase. An additional premium might be viable for advertisements viewed in this manner because a consumer is actively agreeing to view the advertisement (e.g., the advertisement is permitted to be activated and run by the consumer). This is in contrast to traditional advertisements that are now typically blocked by browser software at the behest of the user in an online context and skipped over by digital video recorder (DVR) capabilities in a television context. Because the consumer is requesting to experience the advertisement (and perhaps because of programmatic constraints), the advertiser can be relatively certain that the advertisement will run on the consumer's computer. This benefit to the advertiser is not necessarily available with a traditional pop-up type of advertisement or with traditional television advertising.

The awarded discount credit may be “immediate” such that it is “immediately” applied to a current purchase, which negates the tendency of point programs to become complex, to require unique accounts, to require the storage of information by both consumers and vendors, to change unexpectedly over time, and so forth. Alternatively, the discount credit may be saved and accumulated over time in a user-registered database for subsequent application to a purchase transaction. Discount credit may also be applied against shipping costs.

Moreover, this exchange of a discount for voluntarily experiencing an advertisement may also be implemented in retail stores where a coupon can be issued from a device, such as a kiosk, after an advertisement is experienced. A paper coupon can then be used at a physical checkout, or a code may be entered online to receive the discount. This in-store scheme may be especially pertinent in a promotional situation, e.g., for product launches in which a manufacturer and/or retailer wishes to generate interest in a new product offering. Retail stores already use a relatively simplistic, “dumb” motorized coupon dispenser in some supermarkets to attract the attention of passing customers. When a described in-store embodiment is implemented in such an environment, a consumer can push a button requesting a coupon, and the coupon dispenser can then play an advertisement on a small screen and/or speaker prior to dispensing the coupon. After playing of the advertisement is completed, a discount coupon is dispensed. Many other embodiments are illustrated in the accompanying figures and described herein.

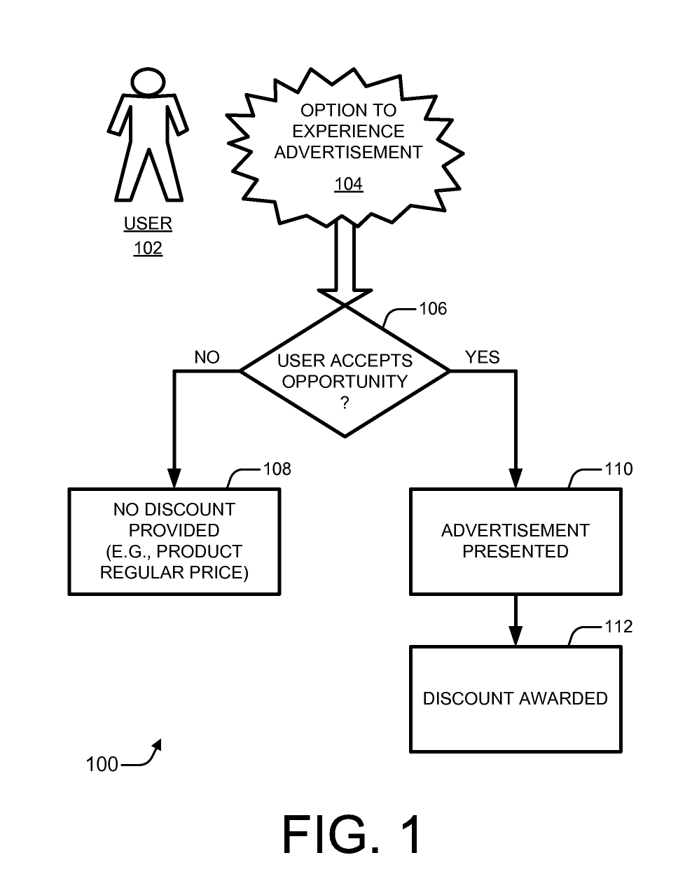

FIG. 1 is a block diagram illustrating an example scheme 100 for awarding discounts in exchange for experiencing advertisements. As illustrated, scheme 100 includes a user 102, an option 104, a determination block 106, and three event blocks 108, 110, and 112. In an example embodiment, a user 102 (e.g., a customer, consumer, wholesaler, other purchaser, etc.) is given an option 104 to experience an advertisement. The advertisement may be experienced visually and/or aurally. In exchange for accepting the offer of an opportunity/option 104 to experience the advertisement, user 102 may earn a discount. The discount may be targeted to a specific product or to a specific vendor, or it may be more generic.

In operation, at determination block 106, it is determined if the user has accepted the opportunity to experience the advertisement. If the user has not accepted the opportunity, then at block 108 no discount is provided. Thus, the user may continue shopping and elect to purchase any product(s) at regular price(s). On the other hand, if the user does accept the opportunity to experience an advertisement (as determined at block 106), then at block 110 the advertisement is presented.

The advertisement may be presented visually and/or aurally to the user. After presentation of the advertisement, the discount is awarded at block 112. In other words, an apparatus that is implementing a scheme 100 enables the user to acquire the discount. The discount may be realized as an immediate price reduction, a coupon code, a physical coupon, an electronic coupon, a transmitted coupon that may be printed, combinations thereof, and so forth. Example embodiments for implementing the concepts, features, and acts of scheme 100 are described herein.

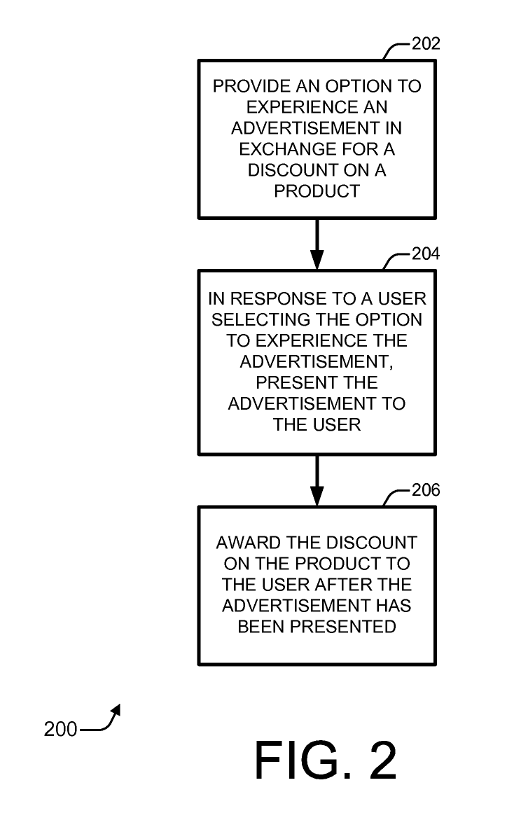

FIG. 2 is a flow diagram 200 of an example general method for awarding discounts in exchange for experiencing advertisements. As illustrated, flow diagram 200 includes three blocks 202-206. In an example embodiment, at block 202, an option to experience an advertisement in exchange for a discount on a product is provided. At block 204, in response to a user selecting the option to experience the advertisement, the advertisement is presented to the user. At block 206, the discount on the product is awarded to the user after the advertisement has been presented. Example embodiments for implementing these acts are described herein.

The amount of the discount may vary in dependence on any number of factors. By way of example only, the amount of a discount on a product may be determined responsive to an amount that is paid by an advertiser for the advertisement to be presented. For instance, the amount of the discount on the product may be a percentage of or actually equal to the amount that is paid by the advertiser for the advertisement to be presented. The discount amount may instead be greater than the amount paid by the advertiser. The amount of the discount may also be dependent on the length of the advertisement, the value of the product being advertised and/or of the product to be discounted, some combination thereof, and so forth.

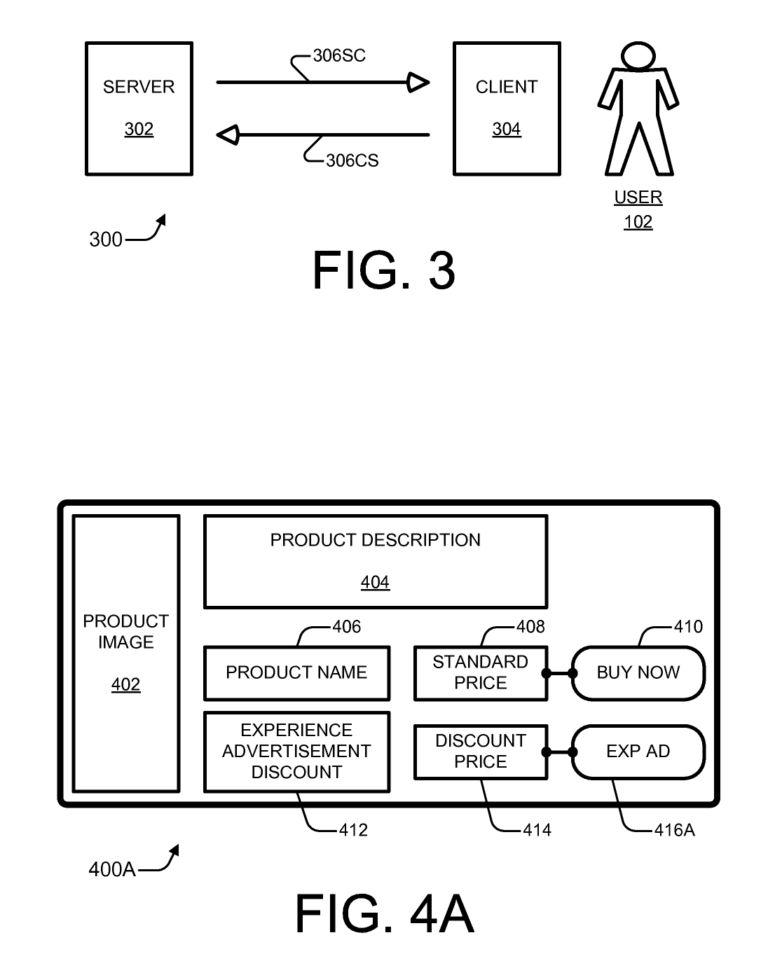

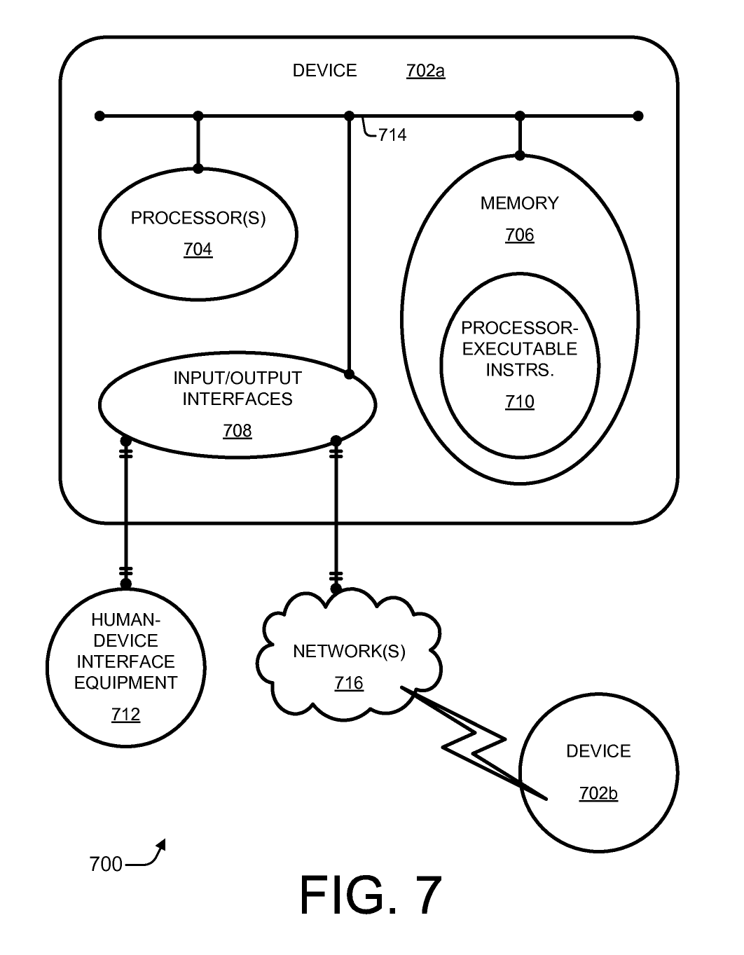

FIG. 3 is a block diagram that illustrates an example client-server environment 300 in which embodiments may be implemented. As illustrated, client-server environment 300 includes a server 302, a client 304, communications 306, and user 102. Communications 306 may include server-to-client communications 306SC and/or client-to-server communications 306CS. Example device embodiments for realizing a server 302 and/or a client 304 are described herein below with particular reference to FIG. 7. For example embodiments generally, client-server environment 300 may pertain to any environment in which one device (e.g., a client 304) is requesting and receiving information from another device (e.g., a server 302).

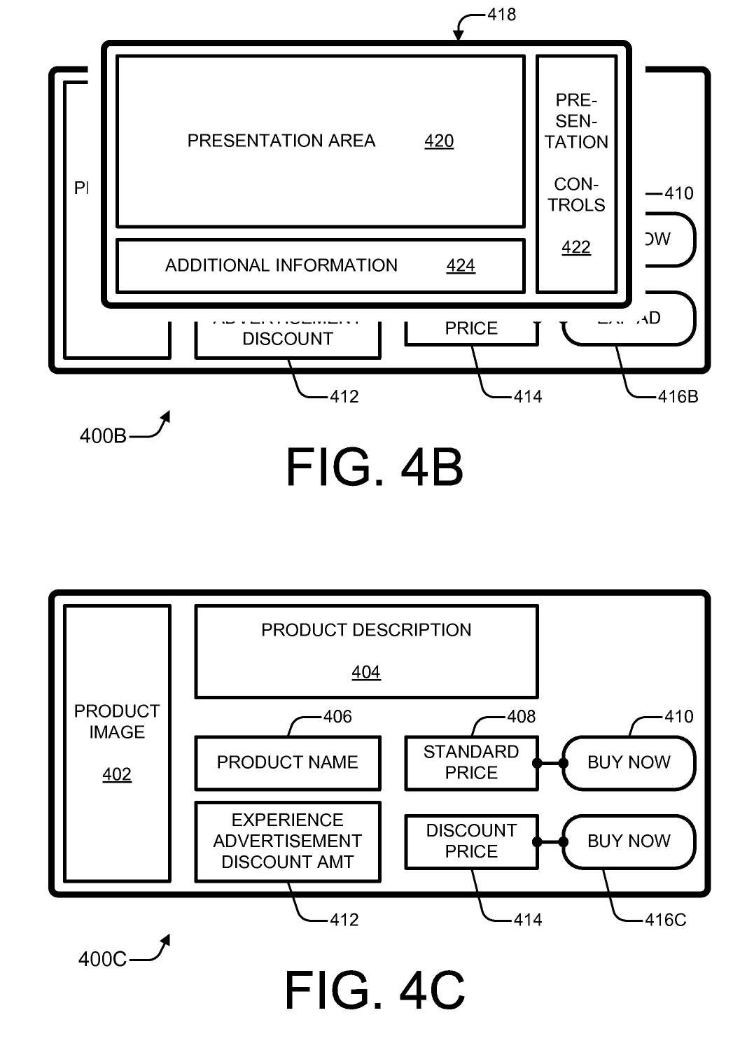

In an example implementation, server 302 is a web server, and client 304 is a personal device that is running a browser program or application. A device for a server 302 may include multiple processors and/or server entities (e.g., machines, virtualized machines, etc.). A device for a client 304 may include multiple processors and be a personal computer (e.g., a laptop, desktop, netbook, etc.), a portable/mobile computer (e.g., a mobile/smart phone, personal digital assistant, entertainment appliance, etc.), a television-based device (e.g., a set-top box), an imaging device (e.g., a printer, multifunction device, etc.), some combination thereof, and so forth. Example client-server environment 300 embodiments are described herein below with particular reference to FIGS. 4A-4C.

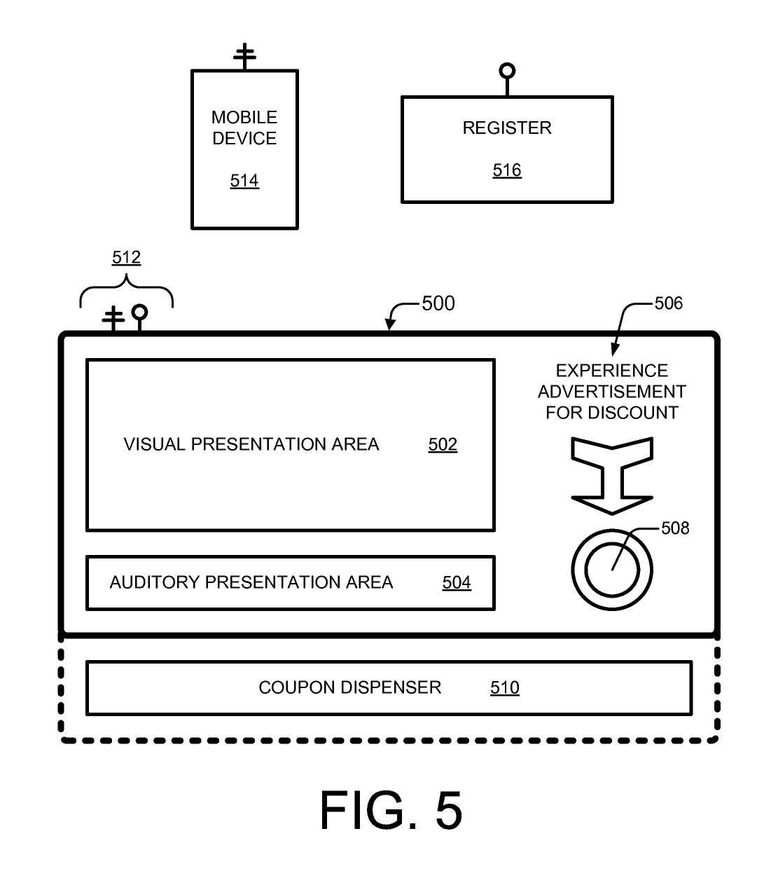

It should be understood that embodiments for awarding discounts in exchange for experiencing advertisements may be implemented in other environments besides client-server environments 300. For example, embodiments may be implemented in the context of an in-store device. In-store devices include, but are not limited to, coupon-dispensing machines, interactive information screens, knowledge kiosks, combinations thereof, and so forth. An example in-store device is described herein below with particular reference to FIG. 5.

FIGS. 4A, 4B, and 4C depict example images 400A, 400B, and 400C, respectively, for a web-based embodiment. As illustrated, each image 400 represents at least a portion of a display screen, such as a window or pane thereof. By way of example only, images 400 may be displayed on a screen of a client 304 (of FIG. 3) based on server-to-client communications 306SC that are received from a server 302. Each image 400 may be, for instance, displayed in a window corresponding to an executing program. An example of a corresponding program is a web browser or other internet-connected program. However, images 400 may alternatively be displayed on screens of clients 304 in different manners and/or be displayed on devices in non client-server environments.

For example embodiments, FIG. 4A corresponds to a first phase in which an option is provided to experience an advertisement in exchange for a discount on a product. FIG. 4B corresponds to a second phase in which an advertisement is presented to a user in response to a user selecting the option to experience the advertisement. FIG. 4C corresponds to a third phase in which the discount on the product is awarded to the user after the advertisement has been presented.

As illustrated, image 400A of FIG. 4A includes a product image zone 402, a product description zone 404, a product name zone 406, a standard price indicator 408, and a “Buy Now” button 410. Image 400A also includes an indication 412 that experiencing an advertisement results in a discount, a discount price indicator 414, and an “Experience Ad” button 416A. Actual implementations may alternatively include more, fewer, and/or different elements than those in image 400A.

In an example embodiment, product image zone 402 includes a picture of the product under consideration. The picture may be switchable, enlargeable, and/or otherwise capable of manipulation. The product may be a good and/or a service. Product description zone 404 includes a textual description of the product under consideration. The official and/or short name of the product is provided at product name zone 406. It may also include a catalog reference number or similar.

The standard, non-discounted price is included at standard price indicator 408. A user may select displayed buttons, links, etc. using a mouse or other manual input device, a finger in touch-sensitive applications, voice for voice-activated applications, and so forth. When a user selects “Buy Now” button 410, the product under consideration is moved into the user's cart, bag, basket, etc. at the corresponding indicated standard price. On the other hand, the user may secure the discounted price by electing to experience an advertisement.

Indication 412 reveals to the user that an advertisement may be experienced in exchange for a discount. By way of example, but not limitation, indication 412 may include a logo; an image; a textual (e.g., alphanumeric) explanation; a title, name, or other indication of a product to be advertised; some combination thereof; and so forth. Indication 412 may also identify the amount of the discount that can be earned. Discount price indicator 414 provides the discounted price of the product (e.g., Standard Price—Discount Amount).

The “Experience Ad” button 416A may also be selected by the user. When a user selects “Experience Ad” button 416A, the associated advertisement is presented. The associated advertisement may be identified in indication 412, may be randomly selected, may be selected based on the product under consideration, may be selected based on other products that have been viewed by the user, may be selected based on previous purchases by the user, may be selected based on survey or demographic information, some combination thereof, and so forth.

As illustrated, image 400B of FIG. 4B further includes an advertisement zone 418. Advertisement zone 418 includes a presentation area 420, presentation controls 422, and additional information 424. Although advertisement zone 418 is shown as being at least part of a pop-up window or overlay area, it may alternatively be presented differently, such as part of or near any of the elements shown in image 400A (of FIG. 4A). Actual implementations may alternatively include more, fewer, and/or different elements than those in image 400B.

In an example embodiment, presentation area 420 shows or plays the advertisement so that it may be viewed by the user. Generally, presentation of an advertisement can entail both visual and audible aspects. However, a given advertisement or presentation thereof may include either a visual aspect or an audible aspect, but not both. Presentation controls 422 include controls to manipulate or adjust the advertisement. By way of example only, presentation controls 422 may include any of the following controls: volume, replay or rewind, pause, and so forth. To ensure that the user has an excellent opportunity to fully enjoy experiencing the complete advertisement, certain controls may be omitted from presentation controls 422, such as mute, fast forward, and so forth. Additional information 424 may include other information relating to the product being advertised. For example, it may include any of the following information for the product being advertised: a name and/or descriptive text, a static image, a link (e.g., to a web site with more information on the advertised product), some combination thereof, and so forth.

After the advertisement has been presented via advertisement zone 418, the user is awarded the discount. Programmatic safeguards may be employed to at least reduce the likelihood that a user may inadvertently miss experiencing all or part of the advertisement. For example, the user may be prevented from receiving and/or utilizing the discount until a full presentation of the advertisement is complete. Advertisement zone 418 may be placed resiliently at a visible, top level of multiple windows on a screen and/or be expanded to fill the screen. As another example, an icon to close the advertisement window or pane may be grayed out or otherwise deactivated. Thus, the advertisement can be set to run for a specific length of time, and then the window may be closed automatically. Other safeguards may also be instituted.

As illustrated, image 400C of FIG. 4C is similar to image 400A (of FIG. 4A). However, in an example embodiment, the “Experience Ad” button 416A is replaced with a “Buy Now” button 416C that corresponds to discount price indicator 414 so as to award the discount to the user. The user may now select the “Buy Now” button 416C to purchase the product under consideration at the discounted price to utilize the discount that has been earned by electing to experience the advertisement. Actual implementations may alternatively include more, fewer, and/or different elements than those shown in image 400C.

The requesting and/or awarding of the discount may be implemented in many alternative manners. For example, button 416A (of FIG. 4A), which corresponds to the discounted price, may read “Buy Now”. When a user selects this “Buy Now” button, an advertisement may be presented, and then the product under consideration may be moved to the user's cart without implementing the third phase of FIG. 4C. Alternatively, the product under consideration may be “immediately” moved into the user's cart after the user selects such a “Buy Now” button 416A that corresponds to the discounted price of indicator 414. The advertisement can then be presented during, but before completion of, the checkout procedure. Also, an electronic coupon (e.g., a code) may instead be emailed to the user.

FIG. 5 depicts an example in-store device embodiment. As illustrated, an in-store device 500 includes a visual presentation area 502 and an auditory presentation area 504. In-store device 500 further includes an indicator 506, which indicates that a discount may be earned in exchange for experiencing an advertisement, and a button 508 to activate the presentation of the advertisement. In-store device 500 may further include communication component(s) 512 and/or a coupon dispenser 510. Actual implementations may alternatively include more, fewer, and/or different elements than those shown in FIG. 5.

In an example embodiment, when button 508 is selected (e.g., pressed or otherwise activated), the advertisement is presented via visual presentation area 502 and/or auditory presentation area 504. Visual presentation area 502 may be implemented, for example, as a screen (e.g., a liquid crystal display (LCD), a light emitting diode (LED) display, some combination thereof, etc.). Auditory presentation area 504 may be implemented, for example, as a speaker. Hence, the advertisement may be viewed and/or heard, depending on the capabilities of in-store device 500 and/or a desired implementation. Alternatively, the advertisement may be transmitted to a mobile device 514 of the user to be experienced via presentation area(s) of the mobile device. After the advertisement is experienced, the discount (e.g., in the form of a coupon) is awarded.

In one example implementation, a communication component 512 is adapted to transmit a coupon for the discount after the advertisement has been presented. Each communication component 512 may include a radio, an antenna, a network interface, and so forth to enable wireless and/or wired communication. In an example operation, the coupon for a discount may be awarded to a user by transmitting the coupon to a register 516 (e.g., within the store) and/or to a mobile device 514 of the user. The transmission may be over a wireless or wireline medium. Example mobile devices 514 include, but are not limited to, a mobile/smart phone, a personal digital assistant (PDA), an entertainment appliance (e.g., music and/or movie player), some combination thereof, and so forth. In another example implementation, an in-store device 500 that includes a coupon dispenser 510 may print a paper coupon to award the discount to the user.

In-store device 500 may be realized in many different manners. For example, it may be implemented as a relatively small device that is clipped or otherwise attached to shelving or another display structure in a store near a particular product. In such an implementation, indicator 506 may be permanent printed text and button 508 may be a physical button. It may alternatively be a larger device with an interactive capability that is posted in a special display area (e.g., on an end cap of a row in a store). In such an implementation, indicator 506 and button 508 may be electronically provided as part of a larger screen. In-store device 500 may also be a full-service kiosk that is placed at the front of a store and offers a number of different services in addition to awarding discounts in exchange for experiencing one or more advertisements. A given in-store device 500 may also incorporate any combination of these and/or other features.

For any of the embodiments (e.g., with regard to FIGS. 4A-4C and 5, with regard to flow diagrams 200 and 600, etc.) that are described herein, the user may be given the opportunity to elect which advertisement from among multiple advertisement is to be viewed. For example, a listing of multiple available advertisements that can be presented may be provided to the user. The user is then empowered to elect a particular advertisement from among the multiple available advertisements that is to be experienced in exchange for a discount. Different respective ones of the multiple available advertisements may correspond to discounts of different respective amounts. By allowing the user to choose the subject matter of the advertisement, it may be better targeted to subjects of interest to the user.

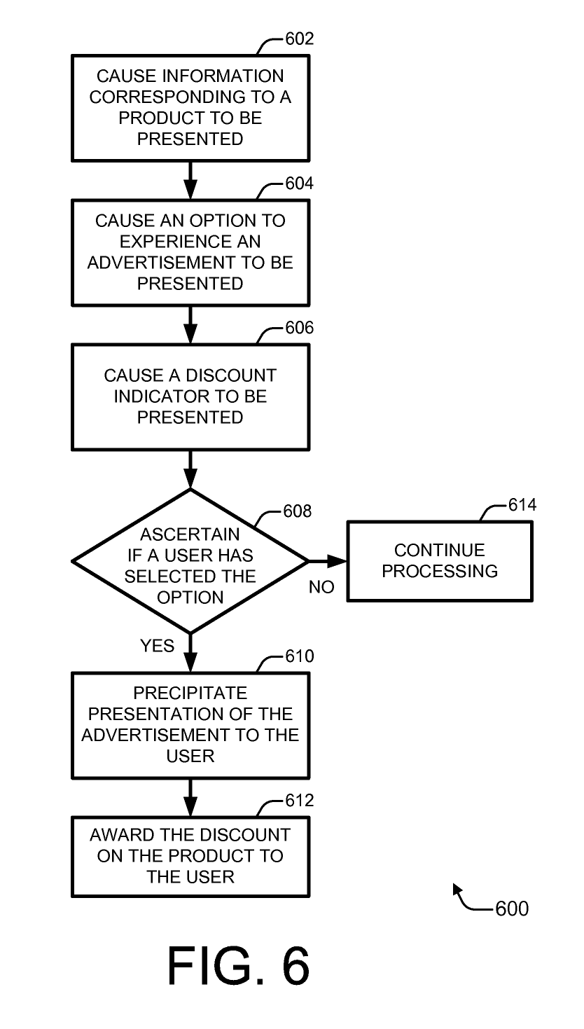

FIG. 6 is a flow diagram 600 of an example specific method for awarding discounts in exchange for experiencing advertisements. As illustrated, flow diagram 600 includes seven blocks 602-614. Although particular example elements from other FIGS. (e.g., FIGS. 3, 4A-4C, and 5) are referenced to describe the blocks of FIG. 6, the acts may alternatively be performed with other elements.

In an example embodiment, at block 602, information corresponding to a product is caused to be presented. For example, information corresponding to a product (e.g., a product image 402, a product description 404, a product name 406, etc.) may be caused to be presented. For instance, a server 302 may send one or more server-to-client communications 306SC to a client 304 to cause the information to be presented. Alternatively, product information may be displayed on a visual presentation area 502 of an in-store device 500.

At block 604, an option to experience an advertisement is caused to be presented. For example, an “Experience Ad” button 416A (or an un-illustrated “Buy Now” button 416A that corresponds to a discount price indicator 414) may be caused to be presented at client 304 by server 302. Alternatively, button 508 may be present on in-store device 500.

At block 606, a discount indicator is caused to be presented, with the discount indicator indicating that selecting the option enables a discount to be acquired (e.g., on the product under consideration that is to be purchased). For example, an indication 412 and/or a discount price indicator 414 may be caused to be presented at client 304 by server 302. Alternatively, indicator 506 and/or indicator(s) from visual presentation area 502/auditory presentation area 504 may be presented by in-store device 500.

At block 608, it is ascertained if a user has selected the option to experience the advertisement. For example, server 302 may ascertain via received client-to-server communications 306CS if a user has selected “Experience Ad” button 416A at client 304. Alternatively, in-store device 500 may ascertain if button 508 has been pressed. If the option is not selected, then at block 614, processing is continued. For example, monitoring for selection of the option or selection of another link/button may be continued.

If, on the other hand, the option is selected (as ascertained at block 608), then at block 610, presentation of the advertisement to the user is precipitated in response to ascertaining that the user has selected the option to experience the advertisement. For example, presentation of the advertisement in presentation area 420 of advertisement zone 418 at client 304 may be precipitated by server 302. The advertisement may originate at server 302 or a different location. Alternatively, an advertisement may be presented via visual presentation area 502 and/or auditory presentation area 504 of in-store device 500.

At block 612, the discount on the product is awarded to the user after the advertisement has been presented. For example, a “Buy Now” button 416C that corresponds to discounted price indicator 414 may be presented and enabled for selection by the user. Also, an offered price may be lowered (e.g., on the product page, when a product is in the user's cart, etc.) to award the discount on the product to the user. Alternatively, a discount in the form of a paper and/or an electronic coupon may be provided to a customer user to award the discount on the product (e.g., in both online client-server environments 300 and in-store device 500 embodiments).

FIG. 7 is a block diagram 700 of example devices 702 that may be used to implement embodiments for awarding discounts in exchange for experiencing advertisements. As illustrated, block diagram 700 includes two devices 702a and 702b, human-device interface equipment 712, and one or more networks 716. As explicitly shown with device 702a, each device 702 may include at least one processor 704, one or more memories 706, one or more input/output interfaces 708, and at least one interconnection 714. Memory 706 may include processor-executable instructions 710. Network(s) 716 may be, by way of example but not limitation, an internet, an intranet, an Ethernet, a public network, a private network, a cable network, a digital subscriber line (DSL) network, a telephone network, a wired network, a wireless network, some combination thereof, and so forth. Device 702a and device 702b may communicate over network(s) 716.

For example embodiments, device 702 may represent any processing-capable device. Example device implementations include, but are not limited to, a server 302, a client 304, an in-store device 500, a mobile device 514, a register 516, some combination thereof, and so forth. Processor 704 may be implemented using any applicable processing-capable technology, and one may be realized as a general-purpose or a special-purpose processor. Examples include, but are not limited to, a central processing unit (CPU), a digital signal processor (DSP), a microprocessor, some combination thereof, and so forth. Memory 706 may be any available memory that is included as part of and/or is accessible by device 702. It includes volatile and non-volatile memory, removable and non-removable memory, hard-coded logic, combinations thereof, and so forth.

Interconnection 714 interconnects the components of device 702. Interconnection 714 may be realized as a bus or other connection mechanism and may directly or indirectly interconnect various components. I/O interfaces 708 may include (i) a network interface for monitoring and/or communicating across network 716 (e.g., communication components 512), (ii) a display device interface for displaying information on a display screen, (iii) one or more human-device interfaces, and so forth. Example network interfaces include, but are not limited to, a radio or transceiver (e.g., a transmitter and/or a receiver), a modem, a network card, some combination thereof, and so forth. Human-device interface equipment 712 may be integrated with or discrete from device 702. Examples of human-device interface equipment 712 include, but are not limited to, screens for images 400 (including touch-sensitive screens); visual presentation area 502; auditory presentation area 504; buttons 410, 416, and 508; combinations thereof, and so forth.

Generally, processor 704 is capable of executing, performing, and/or otherwise effectuating processor-executable instructions, such as processor-executable instructions 710. Memory 706 is comprised of one or more processor-accessible memories. In other words, memory 706 may include processor-executable instructions 710 that are executable by processor 704 to effectuate the performance of functions by device 702. Processor-executable instructions 710 may be embodied as software, firmware, hardware, fixed logic circuitry, some combination thereof, and so forth. Processor 704 and processor-executable instructions 710 of memory 706 may be realized separately (e.g., as a DSP executing code) or integrated (e.g., as part of an application-specific integrated circuit (ASIC)).

In example implementations, one device 702 may comprise a client 304, and another device 702 may comprise a server 302. When processor-executable instructions 710 are executed by processor 704, the functions that are described herein may be effectuated. Example functions include, but are not limited to, those that are illustrated by flow diagrams 200 and 600 (of FIGS. 2 and 6), as well as those that are embodied by the other features that are described herein.

The blocks of the illustrated flow diagrams (e.g., flow diagrams 200 and 600 of FIGS. 2 and 6, respectively) may be effectuated with processor-executable instructions. Processor-executable instructions may be embodied as hardware, firmware, software, fixed logic circuitry, combinations thereof, and so forth. Example operational implementations of processor-executable instructions include, but are not limited to, a memory coupled to a processor, an application-specific integrated circuit (ASIC), a digital signal processor and associated code, some combination thereof, and so forth. Although each of the methods of the illustrated flow diagrams are shown and described in a particular order, the acts thereof may alternatively be performed in other orders, as well as fully or partially overlapping.

The devices, features, functions, methods, acts, schemes, procedures, components, etc. of FIGS. 1-7 are illustrated in diagrams that are divided into multiple blocks and other elements. However, the order, interconnections, interrelationships, layout, etc. in which FIGS. 1-7 are described and/or shown are not intended to be construed as limiting, for any number of the blocks and/or other elements may be modified, combined, rearranged, augmented, omitted, etc. in many manners to implement one or more systems, methods, devices, memories, apparatuses, arrangements, etc. for awarding discounts in exchange for experiencing advertisements.

Although multiple embodiments have been illustrated in the accompanying Drawings and described in the foregoing Detailed Description, it should be understood that the invention is not limited to the disclosed embodiments, for it is also capable of numerous rearrangements, modifications, and substitutions without departing from the scope of the invention as set forth and defined by the following claims.

What is claimed is:

1. A method that is implemented by at least one device for enabling a discount to be earned in exchange for experiencing an advertisement, the method comprising:
causing information corresponding to a product to be presented;
causing an option to experience an advertisement to be presented; and
causing a discount indicator to be presented, the discount indicator to indicate that selecting the option enables a discount on the product to be acquired.

2. The method as recited in claim 1, further comprising:
ascertaining if a user has selected the option to experience the advertisement;
precipitating presentation of the advertisement to the user in response to ascertaining that the user has selected the option to experience the advertisement; and
awarding the discount on the product to the user after the advertisement has been presented.

3. The method as recited in claim 2, wherein the awarding the discount on the product to the user after the advertisement has been presented comprises enabling the user to purchase the product at a price that reflects the discount.

4. The method as recited in claim 1, wherein an amount of the discount on the product is determined responsive to an amount that is paid by an advertiser for the advertisement to be presented.

5. The method as recited in claim 4, wherein the amount of the discount on the product is equal to the amount that is paid by the advertiser for the advertisement to be presented.

6. The method as recited in claim 1, wherein the causing information corresponding to a product to be presented comprises sending the information corresponding to the product from one or more servers over an internet to a client device.

7. The method as recited in claim 1, wherein the causing an option to experience an advertisement to be presented comprises causing a button or link to be included on a web page displayed at a client device.

8. The method as recited in claim 1, wherein the causing a discount indicator to be presented comprises causing an amount of a discount on the product to be presented on a web page displayed at a client device.

9. A method that is implemented by at least one device for enabling a discount to be earned in exchange for experiencing an advertisement, the method comprising:
providing an option to experience an advertisement in exchange for a discount on a product;
in response to a user selecting the option to experience the advertisement, presenting the advertisement to the user; and
awarding the discount on the product to the user after the advertisement has been presented.

10. The method as recited in claim 9, further comprising:
providing a listing of multiple available advertisements that can be presented; and
empowering the user to elect a particular advertisement of the multiple available advertisements that is to be experienced.

11. The method as recited in claim 10, wherein different ones of the multiple available advertisements correspond to discounts of different respective amounts.

12. The method as recited in claim 9, wherein the at least one device comprises a server that performs the providing, the presenting, and the awarding via server-to-client communications that are transmitted to a client device.

13. The method as recited in claim 9, wherein the at least one device comprises an in-store device.

14. An apparatus that enables a discount to be earned in exchange for experiencing an advertisement, the apparatus comprising:
at least one memory including processor-executable instructions;
one or more processors that are configured to execute the processor-executable instructions to:
provide an option to experience an advertisement in exchange for a discount on a product;
in response to a user selecting the option to experience the advertisement, present the advertisement to the user; and
award the discount on the product to the user after the advertisement has been presented.

15. The apparatus as recited in claim 14, wherein the apparatus comprises an in-store device.

16. The apparatus as recited in claim 15, wherein the in-store device further comprises:
a coupon-dispenser that is adapted to dispense a coupon for the discount on the product after the advertisement has been presented.

17. The apparatus as recited in claim 15, wherein the in-store device further comprises:
a communication component that is adapted to transmit a coupon for the discount after the advertisement has been presented.

18. The apparatus as recited in claim 17, wherein the one or more processors are further configured to execute the processor-executable instructions to: transmit the coupon for the discount to a register within the store or to a mobile device of the user.

19. The apparatus as recited in claim 15, wherein the in-store device further comprises:
a display screen that is adapted to display the advertisement when the user selects the option to experience the advertisement.

20. The apparatus as recited in claim 14, wherein the apparatus comprises one or more web servers; and wherein the one or more processors are further configured to execute the processor-executable instructions to:
provide the option to experience the advertisement in exchange for the discount on the product by transmitting the option to a client device;
present the advertisement to the user by transmitting the advertisement to the client device; and
award the discount on the product to the user after the advertisement has been presented by enabling a lower price in an online store or by transmitting a coupon.
